(19) United States
(12) Patent Application Publication
(10) Pub. No.: US 2023/0121845 A1
(43) Pub. Date: Apr. 20, 2023

(54) AIRCRAFT COMPRISING A PLURALITY OF FLYING MODES, AND METHOD FOR OPERATING SAME

(71) Applicant: INNOTEC LIGHTWEIGHT ENGINEERING & POLYMER TECHNOLOGY GMBH, Goslar (DE)

(72) Inventor: Werner HUFENBACH, Goslar (DE)

(21) Appl. No.: 17/905,429

(22) PCT Filed: Mar. 3, 2021
(86) PCT No.: PCT/DE2021/100215

§ 371 Date: Sep. 1, 2022

(30) Foreign Application Priority Data
Mar. 5, 2020 (DE) 10 2020 105 899.3

(51) Int. Cl. B64C 29/00; B64D 9/00; B64D 1/22

(52) U.S. Cl. CPC B64C 29/0008; B64D 1/22; B64D 9/00

(57) ABSTRACT

An aircraft that takes off and lands vertically for transporting people and/or loads, and a method for operating same. The aircraft comprises: a flying unit having a framework structure formed in a plane E, drive units arranged on the framework structure and air-guiding devices each having an adjustable angle of incidence which can be varied between a minimum and maximum angle of incidence; a transport unit comprising a conveying pod and connection device for connecting the conveying pod to the flying unit, the connection device comprising an elongate shaft connecting the conveying pod at one end; and an articulated coupling device for connecting the flying unit to the other end of the elongate shaft. An adjustable tilt angle α of the flying unit can be varied between a minimum angle αₘᵢₙ of 0° ≤ αₘᵢₙ < 30° and a maximum tilt angle αₘₐₓ = 90°.

The invention relates to an aircraft that takes off and lands vertically and is intended for transporting people and/or loads, to a method for operating such an aircraft, to a control unit for controlling such an aircraft, and to a computer program.

Aircraft for transporting people and/or loads are becoming increasingly important because they enable rapid transportation in a manner largely independent of infrastructural facilities such as roads, railways, bridges, tunnels etc. In particular, this applies to smaller aircraft which can take off and land vertically and therefore do not require a runway.

A modular aircraft with a flight module, a transportation module and a coupling device is known for example from WO 2019/114884 A1. The flight module may have air-guiding devices for increasing the efficiency of the aircraft and for stabilizing and/or improving the flow properties during climbing, descending and during cruising flight. Optionally, an angle of incidence of the air-guiding devices may be variable, so that the uplift function of the flight module can be influenced according to the flow conditions. Over and above this, a tilt angle of the flight module may also be varied between 30° and 150°, so that during flight operation, a comfortable vertical orientation of the transportation module in the direction of the gravity line S can be enabled at all times.

Such a configuration is well-suited to short-distance aircraft operation. However, the efficiency of the aircraft in respect of energy consumption during long-distance operation is frequently not sufficient to be able to complete long distances with electric drive with the energy stores currently available.

Against this backdrop, the object of the invention is to indicate possibilities with which the energy efficiency of an aircraft that takes off and lands vertically can be improved.

This object is achieved by the subject matters of the independent claims. Developments of the invention are provided in the dependent claims.

A first aspect of the invention relates to an aircraft that takes off and lands vertically and is intended for transporting people and/or loads. The aircraft has a flying unit with several drive units arranged on a framework structure. Each drive unit may, in turn, have an electric motor and at least one propeller that is in operative connection with the electric motor.

The framework structure is designed to extend in a plane E, wherein the plane E corresponds to the central cross-sectional plane of the framework structure.

The aircraft is what is known as a VTOL (Vertical Take-Off and Landing) aircraft. The flying unit provides the aircraft with uplift.

The framework structure may have radially, axially and tangentially arranged, preferably straight or curved, framework bars which may for example be connected by means of connecting pieces assigned to the framework structure, e.g. T-pieces, at nodal points, and as the case may be to a central unit arranged in the center of the framework structure.

The framework bars that are connected to each other may form a self-contained framework structure, i.e., without exposed ends to the framework bars, which is thereby particularly rigid.

The framework bars may for example be arranged in such a way that a hexagonally strutted framework structure, extending in the plane E, is formed. To this end, six framework bars arranged in an even radial distribution may be provided, so that two adjacent, radially arranged framework bars enclose an angle of approximately 60°. For example, the flying unit in the case of a hexagonal design of the framework structure may have a total of 18 drive units.

In addition to the drive units, one or more air-guiding devices are arranged on the framework structure. The air-guiding devices may have an air foil- or wing-type design, for example panel-shaped or slightly curved, and are each mounted on the framework structure via one bearing shaft of the air-guiding device at an adjustable angle. In the case of an air foil-type design, the air-guiding devices may have a leading edge and a trailing edge, wherein the leading edge, during cruising flight operation, is located in front of the trailing edge, viewed in the direction of flight. Here the suction side is above and the pressure side is below. The air foil-type air-guiding devices may have wing sections extending on both sides of the bearing shaft, wherein one wing section, which during cruising flight operation essentially points in the direction of flight, is defined as the leading wing, and a wing section extending from the bearing shaft in the opposite direction is defined as the trailing wing, which in the flight direction during cruising flight operation is downstream of the leading wing and essentially points in the opposite direction from the direction of flight.

The angles of incidence β₁₋ₙ of the air-guiding devices result from the angular position of the rotatably mounted air-guiding device vis-à-vis the plane E of the framework structure and are in each case adjustable between a minimum angle of incidence β_{1-n,min} and a maximum angle of incidence β_{1-n,max}.

The angle of incidence β₁₋ₙ of any air-guiding device is defined as the larger of the two angles – or where the angles are of equal size, as one of the two equally sized angles – which, starting from the bearing shaft, is enclosed by a central cross-sectional plane Q of the air-guiding device and the plane E of the framework structure.

If the air-guiding device has wing sections extending on both sides of the bearing shaft, then the angle of incidence β₁₋ₙ of any air-guiding device is defined as the larger of the two angles – or where the angles are of equal size, as one of the two equally sized angles – which, starting from the bearing shaft, is enclosed by a central cross-sectional plane Q of the same wing section of an air-guiding device and the plane E of the framework structure.

The angle of incidence β₁₋ₙ is therefore always defined in an angle range between 90° and 180°.

Where the setting / spread of the air-guiding devices or of the wing sections of the air-guiding devices is smaller vis-à-vis the plane E of the framework structure, correspondingly larger angles of incidence β₁₋ₙ are generated.

Where the setting / spread of the air-guiding devices or of the wing sections of the air-guiding devices is larger vis-à-vis the plane E of the framework structure, correspondingly smaller angles of incidence β₁₋ₙ are generated.

Where the setting / spread of the air-guiding devices or of the wing sections of the air-guiding devices is at a minimum vis-à-vis the plane E of the framework structure, the maximum angles of incidence β_{1-n,max} may preferably lie in a range 150° ≤ β_{1-n,max} ≤ 180°, particularly preferably near 180°.

Where the setting / spread of the air-guiding devices or of the wing sections of the air-guiding devices is at a maximum vis-à-vis the plane E of the framework structure, correspondingly minimum angles of incidence β_{1-n,min} are generated in a range 90° ≤ β_{1-n,min} ≤ 120°, particularly preferably near 90°.

In the case of the maximum setting of the air-guiding device or of the wing sections of the air-guiding device in a minimum angle of incidence βₘᵢₙ of 90°, the air-guiding device or the wing sections are aligned essentially perpendicular to the plane E. Here, both the wing section of the air-guiding device pointing in the direction of flight during cruising flight operation (leading wing) and the wing section of the air-guiding device pointing away from the direction of flight during cruising flight operation (trailing wing) can be positioned vertically upwards.

In the case of the minimum setting of the air-guiding device or of the wing sections of the air-guiding device in a maximum angle of incidence βₘₐₓ of 180°, the air-guiding device or the wing sections of the air-guiding device essentially lie(s) in one plane with the framework structure. At the same time the wing section of the air-guiding device pointing in the direction of flight during cruising flight operation (leading wing) and also the wing section of the air-guiding device pointing away from the direction of flight during cruising flight operation (trailing wing) may lie in any desired direction in the plane E of the framework structure.

In the case of several air-guiding devices, the respective angles of incidence β₁₋ₙ may be variable independently of one another, however a minimum angle of incidence β_{1-n,min} and a maximum angle of incidence β_{1-n,max} are defined for each air-guiding device. The minimum angles of incidence β_{1-n,min} and maximum angles of incidence β_{1-n,max} of the air-guiding devices may be the same or different from each other.

In order to change the angles of incidence β₁₋ₙ, the air-guiding devices may, e.g., be each mounted rotatably around their longitudinal axis L in the framework structure, with the longitudinal axis L of the air-guiding device corresponding to the bearing shaft.

Optionally, the air-guiding devices may be designed moveable in a linear direction vis-à-vis the framework structure. For example, the air foil-type air-guiding devices may be folded onto and folded away from the framework structure.

By varying the angles of incidence β₁₋ₙ, the uplift function of the flying unit can be influenced according to the flow conditions. If the air-guiding devices are aligned each having differently sized angles of incidence B₁₋ₙ, then the steering function of the aircraft may be additionally influenced.

The air-guiding devices may support the uplift effect of the flying unit and additionally serve as steering and flight assistance aids. This may improve the efficiency of the aircraft and contribute to the stabilisation and/or improvement of the flow properties and therefore of the manoeuvrability of the aircraft.

Furthermore, the aircraft has a transportation unit with a conveying pod which serves to encase the people and/or loads to be transported, and with a connection device for connecting the conveying pod to the flying unit. The connection device has an elongate shaft which connects to the conveying pod at one end.

The shaft may for example be designed as a straight shaft with e.g., a rectangular cross section with rounded edges over the circumference of the rod, or with a round or oval cross section to the rod.

The shaft may preferably be designed to be essentially rotationally symmetrical, i.e., for example have the shape of a straight circular cylinder, wherein the longitudinal extension of the cylinder corresponds to the length l of the shaft and the base and top surfaces of the cylinder can also be termed the narrow side.

Preferably the shaft may be as thin as possible, i.e., have a small diameter. A shaft design that is as thin and as rotationally symmetrical as possible significantly reduces the mass and the air resistance of the shaft and thereby of the transportation unit.

The conveying pod is shaped in such a way that it merges with the narrow side of the elongate shaft. The narrow side of the shaft may, in order to improve the aerodynamics, preferably be arranged centrally with respect to the conveying pod. Through this central arrangement of the shaft in relation to the conveying pod, the bending load of the shaft can be minimized.

Preferably, the connection between the conveying pod and the shaft may be designed rigid. For example, the conveying pod and shaft may be joined to each other with a firmly bonded connection, e.g., welded.

Through the design of an elongate shaft and the attachment of the conveying pod to this shaft, advantageously the adherence to a certain distance between the conveying pod and flying unit can be achieved.

In particular, the length l of the shaft or, in the case of a variable-length shaft, the minimum length 1ₘᵢₙ of the shaft, may be selected in such a way that adherence to a safe height distance between the conveying pod and the flying unit can be guaranteed. The safe height distance may be determined in such a way that an adult person using the transportation unit, when standing, cannot touch the coupling device or the flying unit. The safe height distance may -starting with a usable conveying pod height of for example 2 m – be at least 0.5 m, preferably 1.0 m, and more preferably 1.5 m.

By this means, the safety in use can be significantly increased by an undesired contact between the operating person, or person and/or load to be transported, and the flying unit being avoided effectively. In addition, adherence to a certain distance contributes to a reduction in noise pollution for the people to be transported.

In addition, through the arrangement of the conveying pod at a distance from the flying unit, the conveying pod can be positioned outside of the downwash of the propellers of the flight module, which results in a reduction in the air resistance and an improvement in the aerodynamics.

The conveying pod may preferably have an aerodynamically favourable shape, e.g., rotationally symmetrical and/or essentially designed in the shape of a drop, so that during flight operation, firstly the static air resistance of the conveying pod and secondly the impact of the flow around the conveying pod through the rotor operation of the flying unit (dynamic air resistance) can be reduced further. The drop shape of the conveying pod may therefore preferably be essentially extended in the direction of the vertical central axis M of the flying unit.

The drop shape of the conveying pod may merge with the elongate shaft, i.e., the conveying pod may have a lower wide, rounded section which tapers to an upper, slim section in the direction of the shaft. Preferably, for the generation of a favourable aerodynamic shape, the conveying pod may have a connecting section to connect the shaft with a tapering cross section for transition onto the cross section of the shaft.

The drop shape may be reduced in its width, e.g., at right angles to a main flight direction of the aircraft in order to generate the least air resistance possible during cruising flight operation.

Moreover, the aircraft in accordance with the invention has an articulated coupling device for connecting the flying unit to another end of the elongate shaft of the transportation unit.

Here, the ‘other end of the elongate shaft’ means the end that is opposite the conveying pod. In other words, the articulated coupling device can connect the second of the two narrow sides of the shaft to the flying unit.

Designing the coupling device as an articulated coupling device enables an adjustment of the angle or tilt between the flying unit and the transportation unit in different flight phases, e.g., take-off phase, cruising flight phase and landing phase.

The tilt angle α of the flying unit is defined as the smaller angle or, in the case of the angles being equally sized, as one of the two equally sized angles, which is enclosed by a gravity line S, which runs perpendicular to the earth’s surface, and the plane E of the framework structure of the flying unit. A gravity line S runs along the operating direction of the gravitational force acting on the aircraft, i.e. always perpendicular to the earth’s surface. Here, the gravitational force is the force generated by the effect of the earth’s gravitational field that acts on the aircraft.

In the narrower sense, the gravity line S can correspond to a longitudinal axis Ls of the shaft, if the transportation unit is arranged on the flying unit in an orientation that is vertical in relation to the earth’s surface. In other words, the tilt angle α for α < 90° is, regardless of the flight direction of the aircraft, determined between the plane E in the section of the framework structure inclined downwards, i.e., in the direction of the earth’s surface, and the gravity line S. The result of this is that the sum of the tilt angle α and the angle enclosed between the gravity line S and the central axis M of the flying unit is always 90°.

Provision is made for an adjustable tilt angle α to be variable between a minimum tilt angle αₘᵢₙ and a maximum tilt angle αₘₐₓ.

Here, provision is made for the minimum tilt angle αₘᵢₙ to lie in a range 0° ≤ αₘᵢₙ < 30°. From the definition of the tilt angle α, it results that the maximum tilt angle αₘₐₓ = 90°.

Preferably, the minimum tilt angle αₘᵢₙ may lie in a range 0° ≤ αₘᵢₙ < 10°. Particularly preferably, the minimum tilt angle αₘᵢₙ may approximate zero or be zero. With the maximum tilt angle αₘₐₓ = 90°, the plane E of the framework structure is arranged perpendicular to the gravity line S and consequently parallel to the earth’s surface. In this state, the gravity line S may correspond precisely to the central axis M of the flying unit. On acceleration of the aircraft and during cruising flight operation, the plane E of the framework structure may, in the direction of flight, be inclined downwards, i.e., a tilt angle α < 90° is set. During braking of the aircraft or for reverse flight, the plane E of the framework structure may be inclined upwards in the direction of flight, in the process of which a tilt angle of α < 90° is likewise generated. Similarly, a sideways inclination of the plane E is possible if a tilt angle α < 90° is set.

Setting of the tilt angle α may occur by means of a servo motor arranged in the articulated coupling device. Such a servo motor may, advantageously, be a precise angle setting even where a large force effect is acting on the transportation unit, e.g., in the case of a force effect resulting from weight and the force of wind. The servo motor may be combined with a servo controller to give servo drive.

The articulated coupling device may be designed with a damping tool for adjusting the flexibility/vibration of the articulated coupling device.

For this adjustability of the articulated coupling device, the damping tool may for example be a ring- or disc-shaped static friction element (coupling disc) and preferably have two coupling blocks or coupling shells that can be moved under preload force and can be pressed against the coupling disc on both sides, which are designed to collectively generate a frictional connection.

According to the pressing force being exerted by the coupling blocks/coupling shells, adjustment of the friction coefficient of the frictional connection of the articulated coupling device can be set to be controllable, e.g. via a sliding friction value – here, the articulated coupling device can be moved completely loosely, (sliding coupling system)– or an elevated static friction value – here, the articulated coupling device can slip in a slip section against a settable resistance (slip coupling)– or even a very high static friction value, which can achieve a rigid coupling with a torque-proof angle coupling between the flying unit and conveying pod.

The damping tool of the articulated coupling device may for example be used for damping the vibration behaviour of the transportation unit under a wind load and/or while adjusting the tilt angle α of the transportation unit with respect to the flying unit by an appropriate resistance (static friction value) being set for the slip coupling.

Additional damping elements, which could, as the case may be, interfere with the coupling process, may therefore be superfluous.

Through the varying of the tilt angle α, and in particular the possibility of being able to set a minimum tilt angle αₘᵢₙ in a range 0° ≤ αₘᵢₙ < 30°, preferably 0° ≤ αₘᵢₙ < 10°, more preferably αₘᵢₙ → 0°, the flying unit may, during cruising flight, be aligned almost perpendicular to the earth’s surface, i.e., parallel to the gravity line S.

Together with a suitable variation of the angles of incidence β₁₋ₙ of the air-guiding devices, gliding flight can thereby be achieved, something which stands out for its particularly high energy efficiency. Here the drive units serve in particular to provide propulsion, whilst uplift is primarily generated by the appropriately positioned air-guiding devices. The high energy efficiency enables, with a given energy store, longer flight routes to be completed and/or the energy store to be reduced in size and thereby a cost and weight saving for a given flight route.

In addition, varying the tilt angle α enables an essentially vertical alignment of the transportation unit in the direction of the gravity line S, also for a non-parallel alignment of the flying unit with respect to the earth’s surface. By this means, the flying experience can be made more comfortable for the people to be transported, and the fixing of loads in the conveying pod can be superfluous or at least simplified.

Preferably, the angles of incidence β₁₋ₙ of the air-guiding devices and the tilt angle α of the flying unit may be variable in a manner dependent on one another.

When the flying unit is inclined vis-à-vis the gravity line S it is possible, by suitably varying the angles of incidence β₁₋ₙ, for the uplift reduced by the inclination of the flying unit to be increased once again. During acceleration of the aircraft, with a downwardly inclined plane E – in the direction of flight – of the framework structure (α < 90°) the air-guiding devices can be positioned working in opposite directions to support the uplift, e.g. with an angle of incidence β₁₋ₙ in the range of approximately 90° to 135°. During deceleration of the flight module with an upwardly inclined plane E – in the direction of flight – of the framework structure (α > 90°) the air-guiding devices can, here, too, be positioned working in opposite directions to support the uplift, e.g., with an angle of incidence β₁₋ₙ of approximately 90° to 135°.

With these kinds of uplift aids, it is possible not only to improve the uplift of the aircraft and thereby reduce propeller output and save energy, but also, among other things, to improve the manoeuvrability and flight stability of the aircraft.

In accordance with various embodiments, the articulated coupling device may be moveable along the framework structure parallel to plane E between a centric position and an outer position.

Centric position may be used here to mean a position in the area of the central axis M of the aircraft, wherein the central axis M passes through the centre of gravity or centre of mass of the framework structure. The central axis M may correspond to an axis of symmetry of the framework structure. For example, the central axis M may pass through the articulated coupling device if the latter is arranged in the centric position.

Outer position may be used to mean any off-center position on the framework structure outside of the area of the central axis M, for example a position on a radially external end of the framework structure, i.e. an end of the framework structure as far away from the central axis M as possible and/or on an external boundary of the framework structure.

The precise location of the outer position with respect to the framework structure may be dependent on the length l of the shaft or of the distance between articulated coupling device and conveying pod. For example, the outer position may be distanced from a central axis M of the flying unit in such a way that the conveying pod, for the minimum tilt angle αₘᵢₙ, is located outside of an external boundary of the framework structure.

On the one hand, the outer position should be selected to be so far away from the central axis M that for the minimum tilt angle αₘᵢₙ, the conveying pod is at a sufficient distance from the transportation unit, i.e., for example a safe height distance is adhered to. On the other hand, the outer position should be as near as possible to the central axis M so that as compact an aircraft as possible is constructed, whose flight properties are easier to control.

If the shaft is designed to be variable in length, as described below, then this may be taken into account when defining the outer position. The articulated coupling device should then be capable of being moved as far out as possible that for the maximum length lₘₐₓ of the shaft, the above-named criteria are fulfilled.

The moving of the articulated coupling device may for example be enabled along one framework bar, along a pair of opposite framework bars, or along all the framework bars. By this means, the movement may also be used for the purpose of responding to prevailing wind conditions and e.g., offsetting an inclination of the conveying pod through a side wind and/or enabling better load distribution.

The slidability of the articulated coupling device may for example be achieved by means of a linear drive unit. The linear drive unit may e.g., comprise a linear sliding device with a track system arranged on the framework structure, in or on which a slide is moveably mounted, e.g., using a ball bearing, which supports the articulated coupling device.

The propulsion of the linear sliding device may for example occur by means of a driven spindle, which is formed by a rotatable rack or threaded rod, or by means of a toothed belt driven all the way around, wherein the drive for these means of transmission may be electric, e.g., via a servo motor. Alternatively, the drive for the linear sliding device may also be designed to be magnetic or electromagnetic.

Such a linear drive unit may, advantageously, enable powerful acceleration, deceleration and rapid switching of operations and thereby a fast change of direction.

Preferably, provision may be made for the articulated coupling device to be moveable, as a function of the tilt angle α, along the framework structure parallel to plane E. Together with the articulated coupling device, the associated transportation unit also shifts.

The slidability of the articulated coupling device therefore enables, advantageously, a change in the position of the transportation unit vis-à-vis the flying unit or its framework structure. For example, the articulated coupling device may be slidable in such a way along the framework structure parallel to plane E that the conveying pod, for the minimum tilt angle αₘᵢₙ, is located radially outside of the flying unit.

Put differently, the change in position of the transportation unit enables an approximately vertical orientation of plane E of the framework structure with respect to the earth’s surface, so that the uplift effect of the air-guiding devices can be optimally, i.e., energy-efficiently, used through appropriate adjustment of the angles of incidence β₁₋ₙ.

In accordance with additional embodiments, a length l of the elongate shaft may be designed variable between a minimum length lₘᵢₙ and a maximum length lₘₐₓ.

The maximum length lₘₐₓ of the shaft may be of such a length that the conveying pod αₘᵢₙ is located outside of an external boundary of the framework structure, i.e., radially outside of the flying unit, for the minimum tilt angle. For example, the maximum length lₘₐₓ may be greater than or equal to the radius of the external boundary of the framework structure.

Preferably, provision may be made for the length l of the shaft to be variable as a function of the tilt angle α. For example, the elongate shaft may be designed with a variable length in such a way that its length l increases with decreasing tilt angle α.

The adjustability of the shaft’s length enables an approximately vertical orientation of the plane E of the framework structure, so that the uplift effect of the air-guiding devices can be optimally, i.e., energy-efficiently, used through appropriate adjustment of the angles of incidence β₁₋ₙ.

Variation of the length 1 of the shaft can likewise occur by means of a linear drive unit. Regarding this, please refer to the above statements concerning the linear drive unit with which the slidability of the articulated coupling device can be achieved.

In accordance with further embodiments, provision may be made to connect the framework structure of the flying unit and the connection device of the transportation unit to each other via a damping device.

The damping device serves to absorb the forces arising when the tilt angle α is changed, so that the change in the tilt angle α has no or at most a minor negative impact on the people and/or loads to be transported.

The damping device may for example be designed as a spring damping element, e.g., as pneumatic spring or oil pressure spring.

In accordance with further embodiments, provision may be made for a locking device, designed to lock the elongate shaft, to be arranged on the framework structure.

Preferably, the locking device may be arranged on a radially external end of the framework structure, since by this means more favourable leverage conditions can be generated.

The locking of the shaft on the framework structure may contribute to an increase in the mechanical stability of the aircraft.

In accordance with further embodiments, provision may be made for the flying unit and the transportation unit to have a modular design, so that the flying unit and any desired transportation unit are capable of being connected to and separated from each other by means of the articulated coupling device as desired, e.g., repeatedly.

For this purpose, a first part of the articulated coupling device may be constructed on the flying unit and a second part of the articulated coupling device as a counterpart on the other end of the elongate shaft of the transportation unit. Consequently, by means of the articulated coupling device, a detachable connection can be produced between the shaft and the flying unit.

Preferably, the articulated coupling device may be designed as an automatic coupling device. By this means, automated coupling of the flying unit and/or of the flight module with the transportation unit or transportation module is possible. The coupling process may be performed rapidly and securely, as manual coupling becomes unnecessary.

The articulated coupling device may be designed controllable, so that remote control of the coupling process can be enabled. In addition, the connecting or disconnecting process may be made dependent on different conditions. For example, disconnecting may only be possible if the conveying pod has ground contact. This may contribute to increased safety.

The modular construction enables a flexible combination of transportation and flying units. In other words, different types of transportation and/or flying units can be swapped for each other.

For example, a first transportation unit may be designed for the transportation of people, whilst a second transportation unit is designed for load transport. Similarly, different flying units may be coupled to this unit. The transportation units may for example differ from each other in the number and/or arrangement of the drive units. For example, depending on the load to be transported and/or the flying conditions (wind strength and direction, altitude etc.) flying units with more or fewer drive units can be selected.

A further aspect of the invention relates to a method for operating an aircraft in accordance with the above description, where the aircraft can be operated at least in a take-off phase, a cruising flight phase and a landing phase. Consequently, also with the method according to the invention, the advantages of the aircraft according to the invention are achieved. All the different designs relating to the aircraft according to the invention can be applied analogously to the method according to the invention.

The method makes provision, during the transition from the take-off phase to the cruising flight phase, with variable angles of incidence β₁₋ₙ of the air-guiding devices, for the tilt angle α of the flying unit to be reduced, and during the transition from the cruising flight phase to the landing phase, with variable angles of incidence β₁₋ₙ of the air-guiding devices, for the tilt angle α of the flying unit to be increased.

For example, the tilt angle α can be reduced by the minimum tilt angle αₘᵢₙ being set. The tilt angle α may for example be increased by the maximum tilt angle αₘₐₓ being set.

In advantageous embodiments the method makes provision, during the take-off phase, for the angles of incidence β₁₋ₙ of a particular number of the air-guiding devices to be low, e.g. minimal, or reduced, e.g. minimised, so that the angles of incidence β₁₋ₙ of a particular number of air-guiding devices preferably lie in a range of a minimum angle of incidence β_{1-n,min} from 90° ≤ β_{1-n,min} ≤ 120°.

In a further advantageous embodiment, the method makes provision, during the landing phase, for the angles of incidence β₁₋ₙ of a particular number of the air-guiding devices to be large, e.g. maximum, or increased, e.g. maximized, so that the angles of incidence β₁₋ₙ of a particular number of the air-guiding devices preferably lie in a range of a maximum angle of incidence β_{1-n,max} from 150° ≤ β_{1-n,max} ≤ 180°.

Optionally, during the transition from the take-off phase to the cruising flight phase, the shaft may be extended and/or the articulated coupling device moved along the framework structure parallel to plane E into an outer position. During the transition from the cruising flight phase to the landing phase, the shaft may be shortened and/or the articulated coupling device be moved along plane E of the framework structure into a centric position.

A flight operation of the aircraft may for example be associated with the following processes.

After taking the parked aircraft into operation, it is started and initially operated in a take-off phase. The take-off phase is characterised by an essentially vertical take-off flight and primarily helps the aircraft to gain height. During the take-off phase, the angles of incidence β₁₋ₙ of a certain number of air-guiding devices may be large, for example approx. 180° (air-guiding devices on the framework structure almost adjacent), preferably the angles of incidence β₁₋ₙ of at least a particular number of the air-guiding devices may be small, for example approx. 90° - 120° (air-guiding devices positioned almost vertically).

The tilt angle α here is usually essentially a maximum of approx. 90° (essentially horizontal position of the flying unit in relation to the earth’s surface).

A small deviation of the tilt angle α from 90° in this take-off phase may for example be caused by the prevailing wind pressure.

Small angles of incidence β₁₋ₙ of a particular number of the air-guiding devices in the take-off phase, with a simultaneously large tilt angle α (essentially horizontal orientation of the flying unit in relation to the earth’s surface) enable a climb of the aircraft during take-off that displays low air resistance and is therefore improved.

With a shaft of adjustable length, the length 1 of the shaft is short, e.g., minimal. With an aircraft with slidable articulated coupling device, the articulated coupling device is located in a centric position.

The take-off phase is followed by the transition to the cruising flight phase, which is characterised by an essentially horizontal movement in relation to the earth’s surface. Its primary purpose is to cover the distance between the take-off and landing sites. During the transition from the take-off phase to the cruising flight phase, at least the tilt angle α of the flying unit is reduced, e.g. the minimum angles β_{1-n,min}, αₘᵢₙ are achieved in each case. In addition, the shaft may be extended and/or the articulated coupling device moved along the framework structure parallel to plane E into an outer position.

During the cruising flight phase, the aircraft – depending on the tilt angle α of the flying unit -may preferably be operated with small, e.g., minimum, angles of incidence β₁₋ₙ to medium angles of incidence β₁₋ₙ in order to align the air-guiding devices or their leading wing sections (leading wings) into a position that is pointing favourably, from a flow perspective, in the direction of flight, whilst the flying unit is preferably operated with a small, e.g. minimum, tilt angle α to medium tilt angle α. The length 1 of the shaft is large, e.g., maximum, and the articulated coupling device moved parallel to plane E is located in an outer position.

For the landing of the aircraft, a transition occurs from the cruising flight phase to the landing phase, which is characterised by an essentially vertical landing flight and primarily helps the aircraft to lose height. During the transition from the cruising flight phase to the landing phase, at least the tilt angle α is increased, and at least a particular number of the air-guiding devices are preferably positioned near to the plane E adjacent to the framework structure until e.g. the maximum angles β_{1-n,max}, αₘₐₓ. in each case are achieved. In addition, the shaft may be shortened and/or the articulated coupling device moved along the framework structure parallel to the plane E into a centric position.

In the subsequent landing phase, the aircraft may be operated with e.g., large, up to maximum angles of incidence β₁₋ₙ of a particular number of air-guiding devices of approx. 150 to 180°, and with a preferably maximum tilt angle of the flying unit of αₘₐₓ = 90°.

Such a position of the air-guiding devices lying flat against the plane E of the framework structure, with a simultaneously essentially horizontal alignment of the flying unit in relation to the earth’s surface generates, in the landing phase, a higher air resistance and can therefore enable an improved deceleration of the aircraft during the landing phase.

A new take-off phase may then take place with a tilt angle α that is unchanged in size and with angles of incidence that are unchanged in size or preferably with changed, small angles of incidence β₁₋ₙ. The length l of the shaft is short, e.g., minimum, and the articulated coupling device is located in a centric position.

A further aspect of the invention relates to a control unit for controlling an aircraft in accordance with the above description. The control unit is set up and designed to generate and emit control signals which bring about an adjustment of the tilt angle α and/or an adjustment of the angles of incidence β₁₋ₙ.

Optionally, the control unit may be set up and designed to generate and emit control signals which bring about a change in the length of the elongate shaft and/or a change in a moving position of the articulated coupling device along the framework structure parallel to plane E.

The control signals are emitted to the corresponding actors, i.e., for example drive units, which can bring about the intended changes in angle, length or position.

The control signals may for example cause the aircraft to carry out one of the above-described processes. Consequently, also with the control unit according to the invention, the advantages of the aircraft according to the invention are achieved. All the embodiments relating to the aircraft according to the invention can be applied analogously to the control unit according to the invention.

The control unit may be produced by means of hardware and/or software and be physically constructed from one or more parts. The control unit may be part of a motor control of the aircraft or be integrated into the latter.

The control unit may receive sensor signals, e.g., from sensors for the monitoring of the angles of incidence and the tilt angle, and control inputs, e.g. from a pilot of the aircraft who may be inside or outside of the aircraft, and process these sensor signals and/or control inputs on the basis of instructions or a code programmed into the control unit in accordance with one or more routines. Subsequently, the control unit sends control signals to actors in response to the processed sensor signals and/or control inputs.

For this purpose, the control unit is, signal technology-wise, in an operative connection with actors of the aircraft which e.g., may bring about a change in the angles of incidence β₁₋ₙ, in the tilt angle α, in the length 1 of the shaft and/or a change in position of the articulated coupling device along the framework structure parallel to plane E. The control unit may be arranged internally in the aircraft itself or externally, i.e., outside of the aircraft. With an external arrangement, the data transmission occurs in wireless form, e.g., by means of radio transmission.

A further aspect of the invention relates to a computer program which encompasses commands that cause an aircraft in accordance with the above description to carry out the steps of a method in accordance with the above description.

Consequently, also with the computer program according to the invention, the advantages of the aircraft according to the invention and of the method for its operation are achieved. All of the designs relating to the aircraft according to the invention and the method according to the invention can be applied analogously to the control unit according to the invention.

Here the word computer program is used to mean a program code that can be stored on a suitable medium and/or retrieved via a suitable medium. If this program code is loaded into a computer and/or executed in a computer, a method according to the invention is implemented.

To store the program code, any medium that is suitable for storing software, for example a non-volatile memory integrated in a control device, a DVD, a USB stick, a flashcard or similar, may be used. Retrieval of the program code may for example take place via the Internet, an intranet or via another suitable wireless or wired network.

A further aspect of the invention relates to a computer-readable medium on which the computer program is stored.

Further advantages of the present invention are visible from the figures and the associated description. The following are shown by the figures:

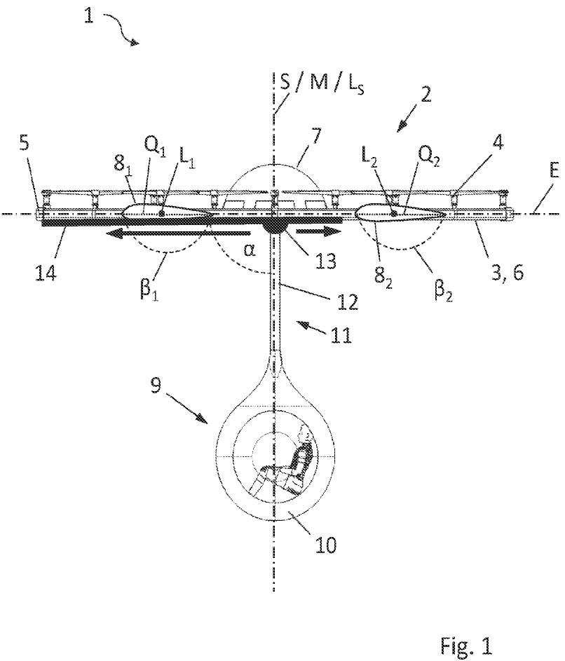

FIG. 1 a schematic representation of an exemplary aircraft with slidable articulated coupling device in the take-off phase, side view;

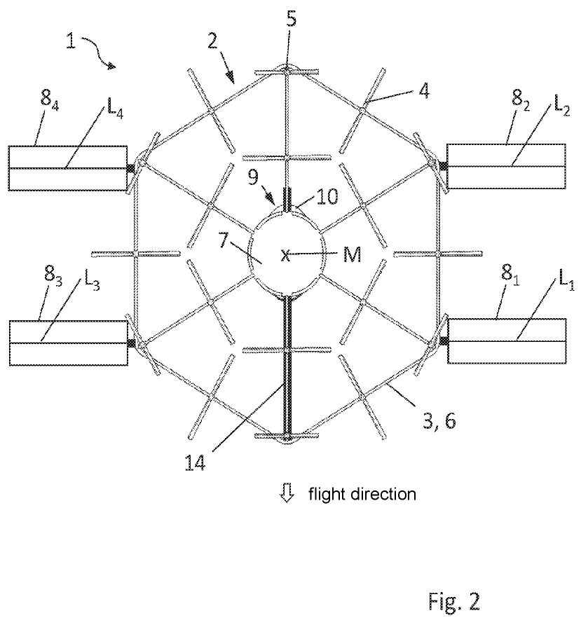

FIG. 2 a schematic representation of the exemplary aircraft from FIG. 1, view from above;

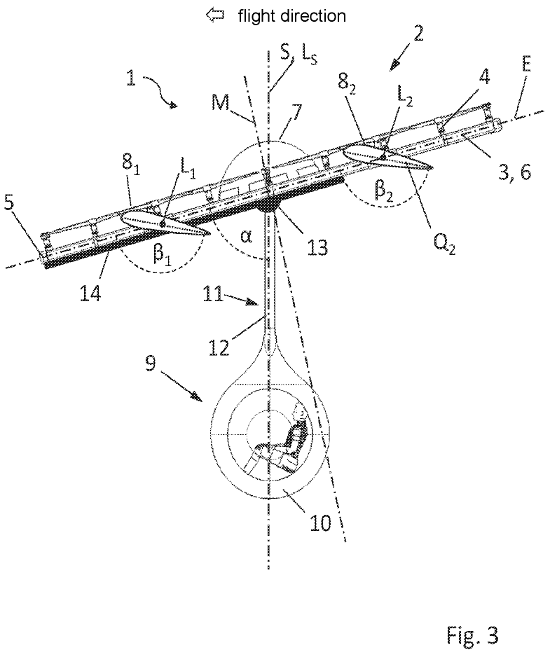

FIG. 3 a schematic representation of the exemplary aircraft during the transition from the take-off phase to the cruising flight phase;

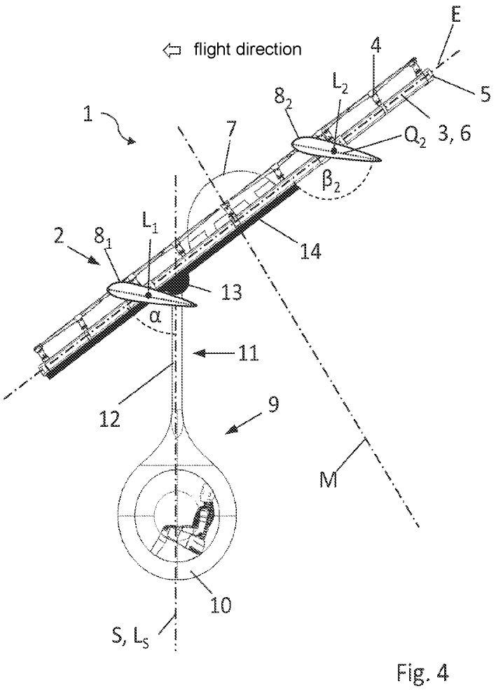

FIG. 4 a further schematic representation of the exemplary aircraft during the transition from the take-off phase to the cruising flight phase;

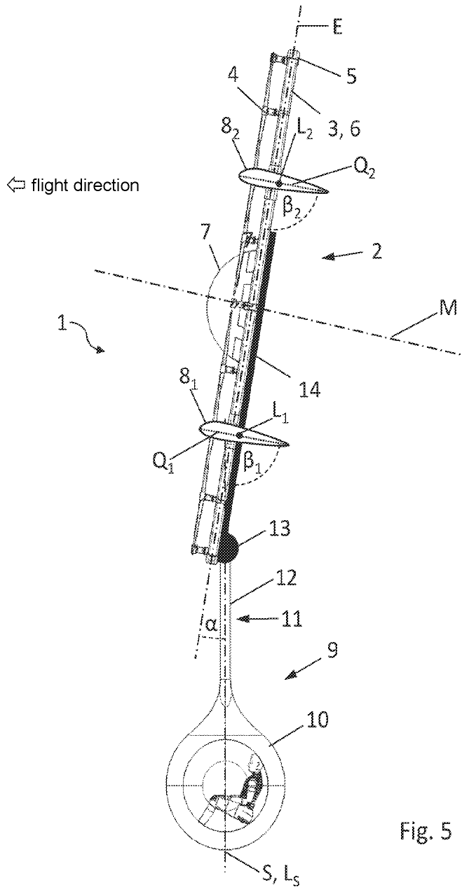

FIG. 5 a schematic representation of the exemplary aircraft in the cruising flight phase;

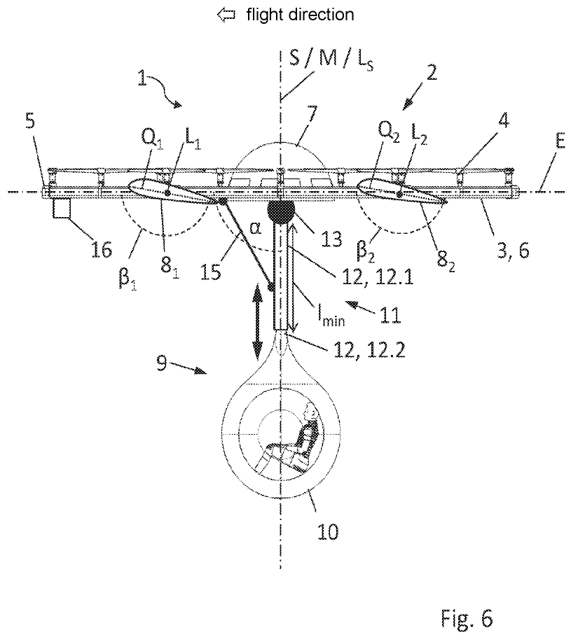

FIG. 6 a schematic representation of a further exemplary aircraft with a variable-length shaft in the take-off phase;

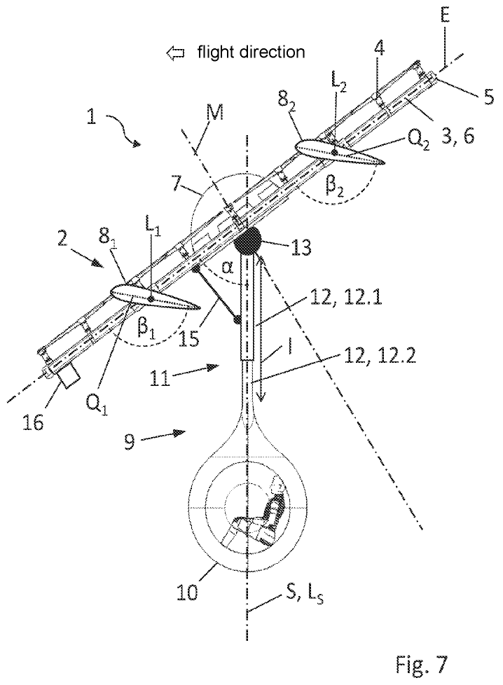

FIG. 7 a schematic representation of the further exemplary aircraft during the transition from the take-off phase to the cruising flight phase; and

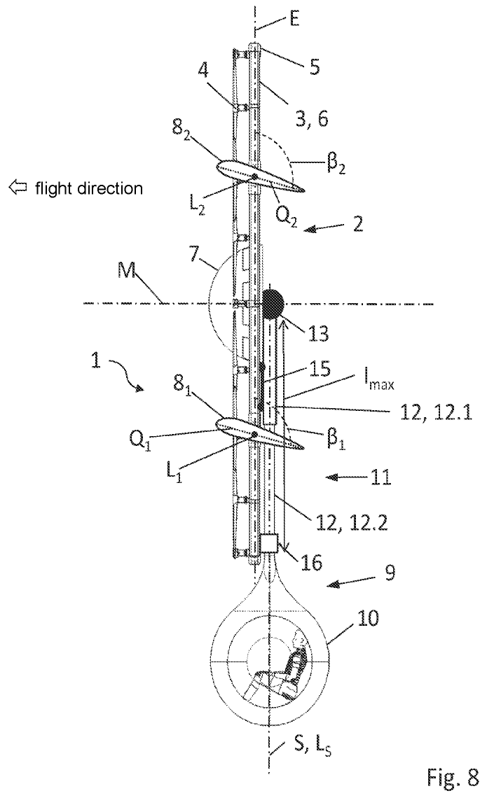

FIG. 8 a schematic representation of the further exemplary aircraft in the cruising flight phase.

In the examples outlined below, reference is made to the attached drawings which form part of the examples and in which, for illustration purposes, specific embodiments are shown in which the invention can be executed. In this respect, direction-related terminology such as “above”, “below”, “front”, “back”, “front”, “rear” etc. is used in relation to the orientation of the figures described. Since components of embodiments can be positioned in a number of different orientations the direction terminology is for illustration purposes and is in no way restrictive.

It goes without saying that other embodiments may be used, and structural or logical changes performed without deviating from the scope of protection of the present invention. It shall be understood that the features of the different exemplary embodiments described here may be combined with one another if not specifically indicated otherwise. For example, both of the embodiments “moveable articulated coupling device” and “variable-length shaft” may be combined with one another so that in one embodiment an aircraft has both a moveable articulated coupling device and a variable-length shaft. The following detailed description is therefore not to be understood in a restrictive sense, and the scope of protection of the present invention is defined by the attached Claims. In the Figures, identical or similar elements are given the identical reference numbers, insofar as it makes sense to do so.

FIGS. 1 to 5 show a first embodiment of an aircraft 1 that take offs and lands vertically, which may be used for transporting people and/or loads. The aircraft 1 comprises a flying unit 2, a transportation unit 9 and an articulated coupling device 13 for the articulated connection of the two units 2, 9.

The flying unit 2 has, in addition to a control unit 7 arranged centrally in relation to the vertical central axis M of the flying unit 2, a framework structure 3 with several framework bars 6, which are connected at nodal points 5 with each other by means of connecting pieces constructed as T-pieces and to the control unit 7. The framework bars 6 consist of a pultruded hollow profile made from fiber-reinforced plastic, e.g., carbon fiber-reinforced plastic. In the hollow profile, cables for signal technology-related connection and energy supply are run. Alternatively, other materials may also be used for the framework bars.

The framework structure 3 is formed from six framework bars 6 running radially outwards from the control unit 7 and from six additional framework bars 6 which connect the ends of the radial framework bars 6 lying opposite the control unit 7 with each other - forming a hexagon - at the nodal points 5 and represent the outer boundary of the framework structure 3 (see FIG. 2).

The framework structure 3 is constructed extended in the plane E, i.e., plane E corresponds to the central cross section level of the framework structure 3.

On the framework structure 3, a total of eighteen drive units 4 are arranged concentrically around the vertical central axis M of flying unit 2. The drive units 4 each have a propeller with a rotor consisting of two rotor blades and a brushless direct current motor as an electric motor, wherein the propeller is driven by the electric motor. By means of a hub of the particular propeller, the latter is mounted rotatably on the electric motor. It goes without saying that the aircraft 1 may also be driven with a different number of drive units 4 or differently designed drive units 4, e.g., with more than two rotor blades in each case.

In addition, four air foil-type air-guiding devices 8₁, 8₂, 8₃, 8₄ are arranged on the framework structure 3; their angles of incidence β₁, β₂, β₃, β₄ are adjustable by being capable of being varied, in each case, between a minimum angle of incidence β_{1,min}, β_{2,min}, β_{3,min}, β_{4,min} and a maximum angle of incidence β_{1,max}, β_{2,max}, β_{3,max}, β_{4,max}. The angles of incidence β₁, β₂, β₃, β₄ are defined as the larger of the two angles or, where the angles are of equal size, as one of the two equally sized angles which, starting with a respective longitudinal axis L₁, L₂, L₃, L₄ of the air-guiding device 8₁, 8₂, 8₃, 8₄, is enclosed by the central cross-sectional plane Q₁, Q₂, Q₃, Q₄ of the same wing section of the respective air-guiding device 8₁, 8₂, 8₃, 8₄ and the plane E of the framework structure 3. To adjust the angles of incidence β₁, β₂, β₃, β₄, the air-guiding devices 8₁, 8₂, 8₃, 8₄ may each be rotated around their longitudinal axis L₁, L₂, L₃, L₄, which are mounted rotatably in the framework structure 3. In this respect, the longitudinal axes L₁, L₂, L₃, L₄ correspond to the bearing shafts of the air-guiding devices 8₁, 8₂, 8₃, 8₄.

In the take-off phase depicted in FIG. 1, the angles of incidence β₁, β₂, β₃, β₄ are each 180°, i.e., the air-guiding devices 8₁, 8₂, 8₃, 8₄ lie in one plane with the framework structure 3. Alternatively, in the take-off phase, single or all of the air-guiding devices 8₁, 8₂, 8₃, 8₄ may, even already during take-off, be positioned slightly angled, with a smaller angle of incidence β₁, β₂, β₃, β₄ less than 180° vis-à-vis the plane E of the framework structure 3, as shown e.g., in FIG. 6, or with a minimum angle of incidence β₁, β₂, β₃, β₄ up to 90° vertically vis-à-vis the plane E of framework structure 3 (not shown).

By changing the angles of incidence β₁, β₂, β₃, β₄ the air flow conditions can be influenced so that e.g., the uplift of the aircraft 1 can be varied.

The control unit 7 has a hemispherical housing made from carbon fibre-reinforced or glass fibre-reinforced plastic. In addition to the control unit 7, rechargeable batteries for supplying the drive units 4 and also other electrical energy consumers with energy may be arranged in the housing. The control unit 7 assists the control of the aircraft 1 by it being set up and designed to generate control signals and emit these to the relevant actors. By means of the control signals, it is possible for example to bring about an adjustment of the angles of incidence β₁, β₂, β₃, β₄.

In addition to the flying unit 2, the aircraft 1 has the transportation unit 9 with a drop-shaped conveying pod 10, wherein the drop shape, in the flying state of the aircraft 1, is essentially extended vertically in relation to the earth’s surface. The conveying pod 10 is designed completely self-contained and has a partially see-through cover, so that people can look out of the conveying pod 10.

Inside the conveying pod 10 are seats equipped with safety belts and airbags, an air conditioning unit, displays and a communication device for communicating with the control unit 7, other aircraft or a ground station (not shown).

The conveying pod 10 is connected by means of the connection device 11 to the flying unit 2, wherein the transportation unit 9 is, in the take-off phase, arranged centrally underneath the flying unit 2. For this, the connection device 11 has an elongate, rotationally symmetrically designed shaft 12, one end of which is attached to the conveying pod 10.

The shaft 12 and the conveying pod 10 have a fiber composite, e.g. a carbon fiber- or glass fiber-reinforced plastic, as a result of which the transportation unit 9 stands out for a low mass whilst simultaneously displaying good mechanical properties.

The coupling of the flying unit 2 with the transportation unit 9 is enabled by the articulated coupling device 13. Its design as an articulated coupling enables a flexible inclined position of the flying unit 2 in relation to the earth’s surface. Because the transportation unit 9 is always aligned vertically in relation to the earth’s surface, i.e. the longitudinal axis Ls of the shaft 12 of the transportation unit 9 follows the gravity line S, a vertical orientation of the transportation unit 9 can also be largely retained with a different orientation of the flying unit 2 during flight operation, and the centre of gravity of the aircraft 1 concentrated on a limited central section, which improves the comfort and the manoeuvrability and controllability of the aircraft 1.

Specifically, the tilt angle α, i.e., the smaller angle or, if the angles are of equal size, one of the two equally sized angles, which is enclosed by the gravity line S (overlaid with the longitudinal axis L_{S} of the shaft 12 of the transportation unit 9) and the plane E of the framework structure 3, can be set by it being varied between a minimum tilt angle αₘᵢₙ and a maximum tilt angle αₘₐₓ.

The minimum tilt angle αₘᵢₙ lies in a range 0° ≤ αₘᵢₙ < 30°, namely at approx. 15° (see FIG. 5), so that an almost vertical arrangement of the flying unit 2 in relation to the earth’s surface is permitted. The maximum tilt angle αₘₐₓ is 90°.

The articulated coupling device 13 is slidable along the framework structure 3 parallel to plane E, specifically between a centric position (FIG. 1) and an outer position (FIG. 5). The slidability, indicated in FIG. 1 by means of arrows, is achieved by means of the linear sliding direction 14, which is designed as a track system. The linear sliding direction 14 extends, in a forward flight direction (in the Figures only termed flight direction), to the outer boundary of the framework structure 3, so that the articulated coupling device 13 and the transportation unit 9 attached to it can likewise be moved to the outer boundary of the framework structure 3.

Contrary to the forwards flight direction, i.e., in a reverse flight direction, the linear sliding direction 14 extends in this embodiment up to approx. ⅓ of the radius of the framework structure 3, beyond the central axis M, in the direction of the opposite outer boundary of the framework structure 3. This enables an unimpeded inclination of the flying unit 2 vis-à-vis the gravity line S, also in the case of a reverse flight, or in a braking situation, or in the event of required shifts of centre of gravity for positional correction of the aircraft.

Alternatively, e.g., from the perspective of weight savings, it is also possible for the linear sliding device 14 to extend only within a radius of the framework structure 3 between the central axis M and the respective outer boundary of the framework structure 3.

Optionally, flying unit 2 and transportation unit 3 may have a modular design. In such a design, the articulated coupling device 13 is preferably designed as an automatic articulated coupling, so that an automatic connection and disconnection of different transportation units 3 or transportation modules to the same flying unit 2 or the same flight module is possible, wherein the transport modules may have different designs. Likewise, different flight modules may be coupled to the same transportation module. The articulated coupling device 13 may also be designed controllable, so that a connection can be produced or loosened between the transportation module and the flight module in a targeted manner.

FIG. 1 shows the above-described aircraft 1 in the take-off phase, i.e., in a flight phase which is characterized by an essentially vertical flight from a take-off location to gain height. The statements relating to the take-off phase apply analogously to the landing phase, which is characterized by an essentially vertical flight to a target location to lose height.

In the take-off phase shown, the angles of incidence β₁, β₂, β₃, β₄ are approx. a maximum of 180°, i.e., the central cross-sectional planes Q₁, Q₂, Q₃, Q₄ of the air-guiding devices 8₁, 8₂, 8₃, 8₄ are essentially aligned parallel to the plane E. The tilt angle α is 90° and the articulated coupling device 13 is located in a centric position.

During the transition, shown in FIGS. 3 and 4, from the take-off phase (FIG. 1) to the cruising flight phase (FIG. 5), the flying unit 2 is inclined downwards in the direction of flight. As a consequence, the tilt angle α is reduced. The transportation unit 3 is unchanged and essentially aligned vertically in relation to the earth’s surface. At the same time, the angles of incidence β₁, β₂, β₃, β₄ are also reduced (slight to moderate positioning of the air-guiding devices 8₁, 8₂, 8₃, 8₄ from the position parallel to plane E, with leading wing sections (leading wings) essentially pointing in the direction of flight, in order to achieve an improved uplift effect of the aircraft 1.

With increasing reduction in the tilt angle α, the position of the articulated coupling device 13 is also pushed outwards from the centric position (FIG. 4). At the same time, the angles of incidence β₁, β₂, β₃, β₄ are reduced further so that the air-guiding devices 8₁, 8₂, 8₃, 8₄ or the leading wings essentially point in the direction of flight until the cruising flight phase as per FIG. 5 is reached.

The cruising flight phase shown in FIG. 5 enables larger distances to be covered and is characterized by a trajectory that runs essentially parallel to the earth’s surface. The cruising flight phase is completed with minimum angles of incidence β_{1,min}, β_{2,min}, β_{3,min}, β_{4,min} and the minimum tilt angle αₘᵢₙ. The articulated coupling device 13 is located in the outer position, i.e., on the outer end of the linear sliding device 14.

Here the outer position is sufficiently far from the central axis M of the flying unit 2 that the conveying pod 10 is situated outside of the outer boundary of the framework structure 3.

FIGS. 6 to 8 show an additional embodiment of an aircraft 1. Concerning the general structure and mode of functioning, please refer to the statements concerning the first embodiment.

Unlike the embodiment in accordance with FIGS. 1 to 5, the articulated coupling device 13 is not slidable, but always stays in the centric position.

However, the length l of the shaft 12 is variable between a minimum length lₘᵢₙ and a maximum length lₘₐₓ. This is indicated in FIG. 6 by means of a double arrow. The length 1 of the shaft 12 corresponds to the distance between the articulated coupling device 13 and conveying pod 10.

In addition, a damping device 15 and a locking device 16 are optionally present.

The separate damping device 15 may for example be used if the articulated coupling device 13 does not have a damping tool or the damping effect of the damping tool of the articulated coupling device 13 must be supported for certain applications.

In the take-off phase or landing phase (FIG. 6), the length l of the shaft 12 is at its minimum, so that the aircraft 1 has a compact design. However, a safety height distance is present between the conveying pod 10 and the articulated coupling device 13, which is predetermined by the minimum length 1ₘᵢₙ.

During the transition from the take-off phase to the cruising flight phase and/or during the transition from the cruising flight phase to the landing phase (FIG. 7), the change in the angles of incidence β₁, β₂, β₃, β₄ and the tilt angle α occurs as described for the first embodiment.

In addition, during the transition from the take-off phase to the cruising flight phase, the length l of the shaft 12 is extended or, during the transition from the cruising flight phase to the landing phase, is shortened. This is for example achieved by a lower shaft part 12.2 connected to the conveying pod 10 being pulled out, in the manner of a telescope, from the upper shaft part 12.1 firmly connected to the articulated coupling device 13 and/or drawn into this.

The tilting process of the flying unit 2 vis-à-vis the conveying pod 10 is absorbed by means of the damping device 15.

In the cruising flight phase (FIG. 8), the length l of the shaft 12 is at its maximum. The shaft 12 can essentially be aligned parallel to the plane E of the framework structure 3, so that a minimum tilt angle αₘᵢₙ of as little as 0° is generated.

To improve the stability of the aircraft 1, the shaft 12 can be attached to the framework structure 3 by means of the locking device.

The maximum length lₘₐₓ of the shaft 12 has such dimensions that the conveying pod 10, for the minimum tilt angle αₘᵢₙ, is located outside of the outer boundary of the framework structure 3.

During the transition from the cruising flight phase to the landing phase, the above-described processes are carried out in the reverse order.

The expression “and/or” used here, if used in a series of two or more elements, means that each of the elements listed can be used on their own, or any combination of two or more of the listed elements can be used.

If for example a relationship is described which contains the components A, B and/or C, the relationship may contain the components: only A; only B; only C; A and B in combination; A and C in combination; B and C in combination; or A, B, and C in combination.

List of Reference Signs

| | |
|---|---|
| 1 | aircraft |
| 2 | flying unit |
| 3 | framework structure |
| 4 | drive unit |
| 5 | nodal point |
| 6 | framework bar |
| 7 | control unit |
| 8, 8₁, 8₂... 8ₙ | air-guiding device |
| 9 | transportation unit |
| 10 | conveying pod |
| 11 | connection device |
| 12 | shaft |
| 12.1 | upper shaft part |
| 12.2 | lower shaft part |
| 13 | articulated coupling device |
| 14 | linear sliding device |
| 15 | damping device |
| 16 | locking device |
| E | plane of framework structure |
| L, L₁, L₂ ... Lₙ | longitudinal axis of air-guiding device |
| L_{S} | longitudinal axis of shaft |
| M | central axis of flying unit |
| Q, Q₁, Q₂ ... Qₙ | central cross section plane of air-guiding device |
| S | gravity line |
| l | length of shaft |
| lₘᵢₙ | minimum length of shaft |
| lₘₐₓ | maximum length of shaft |
| α | tilt angle |
| αₘᵢₙ | minimum tilt angle |
| αₘₐₓ | maximum tilt angle |
| β, β₁, β₂ ... βₙ | angle of incidence |
| β_{1-n,min} | minimum angle of incidence |
| β_{1-n,max} | maximum angle of incidence |

1-16. (canceled)

17. An aircraft that takes off and lands vertically, for transporting people and/or loads, wherein the aircraft comprises:
a flying unit, having a framework structure formed in a plane E, drive units being arranged on the framework structure, and air-guiding devices, each with an adjustable angle of incidence β₁₋ₙ, each angle of incidence β₁₋ₙ being variable between a minimum angle of incidence β_{1-n,min} and a maximum angle of incidence β_{1-n,max},
a transportation unit comprising a conveying pod and a connection device for connecting the conveying pod to the flying unit, the connection device having an elongate shaft, one end of which is attached to the conveying pod, and
an articulated coupling device for an articulated connection of the flying unit to another end of the elongate shaft, such that an adjustable tilt angle α of the flying unit is variable between a minimum tilt angle αₘᵢₙ in a range 0° ≤ αₘᵢₙ < 30 and a maximum tilt angle αₘₐₓ = 90°.

18. The aircraft of claim 17, wherein the minimum tilt angle αₘᵢₙ is 0° ≤ αₘᵢₙ ≤ 10°.

19. The aircraft of claim 17, wherein the articulated coupling device is slidable along the framework structure parallel to the plane E between a centric position and an outer position.

20. The aircraft of claim 17, wherein a length 1 of the shaft is variable between a minimum length 1ₘᵢₙ and a maximum length 1ₘₐₓ.

21. The aircraft of claim 19, wherein the outer position is located at a distance from a central axis M of the flying unit in such a way and/or wherein a maximum length 1ₘₐₓ of the shaft is such that the conveying pod, for the minimum tilt angle αₘᵢₙ, is located outside of an outer boundary of the framework structure.

22. The aircraft of claim 21, wherein the outer position is located at a distance from a central axis M of the flying unit in such a way that the conveying pod, for the minimum tilt angle αₘᵢₙ, is located outside of an outer boundary of the framework structure.

23. The aircraft of claim 21, wherein a maximum length 1ₘₐₓ of the shaft is such that the conveying pod, for the minimum tilt angle αₘᵢₙ, is located outside of an outer boundary of the framework structure.

24. The aircraft of claim 19, wherein the articulated coupling device, as a function of the tilt angle α, is slidable along the framework structure parallel to the plane E and/or wherein the length 1 of the shaft is variable as a function of the tilt angle α.

25. The aircraft of claim 24, wherein the articulated coupling device, as a function of the tilt angle α, is slidable along the framework structure parallel to the plane E.

26. The aircraft of claim 24, wherein the length 1 of the shaft is variable as a function of the tilt angle α.

27. The aircraft of claim 17, wherein the framework structure and the connection device are connected to each other via a damping device.

28. The aircraft of claim 17, wherein on the framework structure a locking device, configured to lock the shaft, is arranged.

29. The aircraft of claim 17, wherein the flying unit and the transportation unit have a modular design, so that the flying unit and any transportation unit can be joined to each other and separated from each other as desired by means of the articulated coupling device.

30. The aircraft of claim 17, wherein the air-guiding devices are shaped in the manner of air foils.

31. A method of operating the aircraft of claim 17, wherein the aircraft can be operated in at least one take-off phase, a cruising flight phase and a landing phase, and wherein
during a transition from the take-off phase to the cruising phase, the tilt angle α of the flying unit is reduced, and
during a transition from the cruising flight phase to the landing phase, the tilt angle α of the flying unit is increased.

32. The method of claim 31, wherein
during the take-off phase, the angles of incidence β₁₋ₙ of a particular number of the air-guiding devices (8₁₋ₙ) are reduced, and /or
during the landing phase, the angles of incidence β₁₋ₙ of a particular number of the air-guiding devices (8₁₋ₙ) are increased.

33. The method of claim 32, wherein
during the take-off phase, the angles of incidence β₁₋ₙ of a particular number of the air-guiding devices (8₁₋ₙ) are reduced into a range of a minimum angle of incidence β_{1-n,min} from 90°≤ β_{1-n,min} ≤ 120° and/or
during the landing phase, the angles of incidence β₁₋ₙof a particular number of the air-guiding devices (8₁₋ₙ) are increased into a range of a maximum angle of incidence β_{1-n,max} from 150° ≤ β_{1-n,max} ≤ 180°.

34. The method of claim 31, wherein
during the transition from the take-off phase to the cruising flight phase, the shaft of the transportation unit is extended and/or the articulated coupling device is slid along the framework structure parallel to the plane E into an outer position, and
during the transition from the cruising flight phase to the landing phase, the shaft of the transportation unit is shortened and/or the articulated coupling device is slid along the framework structure parallel to the plane E into a centric position.

35. A control unit for controlling the aircraft of claim 17, wherein the control unit is set up and configured for generating and emitting control signals which bring about an adjustment of the tilt angle α and/or an adjustment of the angles of incidence β₁₋ₙ.

36. The control unit of claim 35, wherein the control unit is set up and configured for generating and emitting control signals which bring about a change in length of the shaft and/or a change in a sliding position of the articulated coupling device along the framework structure parallel to the plane E.
